(19) United States
(12) Patent Application Publication
(10) Pub. No.: US 2004/0136515 A1
(43) Pub. Date: Jul. 15, 2004

(54) Off-hold alert for telecommunications devices

(76) Inventor: Louis Robert Litwin JR., Plainsboro, NJ (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 10/345,691

(22) Filed: Jan. 15, 2003

(51) Int. Cl. H04M 3/42

(52) U.S. Cl. 379/202.01; 379/207.04

(57) ABSTRACT

There is provided a method for alerting a telecommunications user that a party to a voice conference has returned from hold. The method includes the steps of detecting when a party to the voice conference has returned from a hold mode that has disengaged the voice conference, and providing an alert to a telecommunications user, in response to a result of said detecting step, informing the telecommunications user about the re-engagement of the voice conference. An apparatus is also described in accordance with the principles of the method of alerting a telecommunications user that a party to a voice conference has returned from hold,

### FIELD OF THE INVENTION

The present invention generally relates to telecommunications devices and, more particularly, to a method and apparatus for alerting a telecommunications user that one or more other parties to a voice conference have come back from a hold mode.

### BACKGROUND OF THE INVENTION

A user of a telecommunications device, such as a telephone, voice over Internet protocol (VoIP) enabled device, and the like, may often be placed on hold for an indeterminate amount of time, during a voice conference between at least two parties. When a first party places a second party on hold, the second party is subjected to hearing announcements, music, or even silence during the duration of the on hold period. During this time, the second party may desire to put the telecommunications device down and to do other things. However, in doing so, the second party risks missing the re-engagement of the voice conference if the second party is not listening to the telecommunications device when the first party returns from hold.

Accordingly, it would be desirable and highly advantageous to have a method and apparatus for alerting a telecommunications user to when one or more other parties to a voice conference have come back from hold.

### SUMMARY OF THE INVENTION

A method and apparatus for alerting a telecommunications user that one or more other parties to a voice conference have come back from hold, re-engaging a voice conference.

### BRIEF DESCRIPTION OF THE DRAWINGS

FIG. 1 is a block diagram illustrating an apparatus 100 for a telecommunications device, according to an illustrative embodiment of the present invention;

FIG. 2 is a block diagram illustrating a telecommunications system 200, according to an illustrative embodiment of the present invention;

FIG. 3 is a flow diagram illustrating a method for alerting a telecommunications user that a party to the voice conference has returned from a hold mode, according to an illustrative embodiment of the present invention;

FIG. 4 is a flow diagram illustrating a method for alerting a telecommunications user (hereinafter “user”) that a party to the voice conference has returned from hold, according to another illustrative embodiment of the present invention;

FIG. 5 is a block diagram illustrating a Voice over Internet Protocol (VoIP)/Video Conferencing System utilizing the H.323 standard, according to the prior art;

FIG. 6 is a block diagram illustrating a H.323 protocol stack, according to the prior art; and

FIG. 7 is a flow diagram illustrating a method for a Voice over Internet Protocol (VoIP) based conference system, according to an illustrative embodiment of the present invention.

FIG. 8 is a flow diagram illustrating a method for a telecommunications device user subject to a hold sequence to enable a callback sequence to a party placing the user on hold.

### DETAILED DESCRIPTION OF THE INVENTION

The present invention is directed to a method and apparatus for alerting a telecommunications user that one or more other parties to a voice conference have come back from a hold mode. The present invention applies to many types of telecommunications devices including, but not limited to, telecommunications devices connected by landline, cellular telecommunications devices and other types of wireless communication devices, Voice over Internet Protocol (VoIP) enabled telecommunications devices, and any combination thereof. It is to be further appreciated that a voice conference according to the present invention may support two or more participants. For the purposes of the present invention, a telephone call between at least two parties is considered as a form of voice conferencing.

It is to be understood that the present invention may be implemented in various forms of hardware, software, firmware, special purpose processors, or a combination thereof. Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

Because some of the constituent system components and method steps depicted in the accompanying Figures are preferably implemented in software, the actual connections between the system components (or the process steps) may differ depending upon the manner in which the present invention is programmed.

There is provided, according to an aspect of the present invention, a method for alerting a telecommunications user that a party to a voice conference has returned from hold. The method includes the steps of detecting when the other party to the voice conference has returned from hold, and providing an alert to the telecommunications user in response to a result of the detecting step.

According to another aspect of the present invention, there is provided a telecommunications apparatus including a detection device and an alarm. The detection device detects when the other party to a voice conference has returned from hold. The alarm alerts a user of the telecommunications device when the detection device detects that the other party to the voice conference has returned from hold.

According to yet another aspect of the present invention, there is provided a telecommunications system. The telecommunications system includes a first telecommunications device associated with a first user (other party) and a second telecommunications device associated with a second user. The first telecommunications device has a capability of placing a second user in and out of a hold mode. The second telecommunications device detects when the second user has been removed from hold and provides an alert in response thereto.

A hold mode is defined as a state where a user to a two party (or more) based communication (via a communications network, as a voice call or a data connection) is temporarily disengaged from the communication, based on the actions of the “other party” to the communication. Such an action occurs, for example, when two parties are communicating via a telephone call transmitted through a public switched telecommunications network (PSTN). The other party to the telephone call receives a signal that there is a third party (not part of the current telephone call) trying to reach the other party (via call waiting). The other party temporarily disengages the user from the telephone call by initiating a hold mode, to communicate with the third party. The user is then switched, to a second telephone line or other type of queue that maintains the telephone connection during “the hold state”. When the other party re-engages the user back to the telephone call, the hold mode is terminated; such a re-engagement eliminates the need for the other party to initiate a new telephone communication with the user. Hold modes may be used in other voice based communications settings such as a Voice over Internet Protocol communication, Internet Messaging communications, and other types of at least two party communications conducted over a communications network.

FIG. 1 is a block diagram illustrating an apparatus 100 for a telecommunications device, according to an illustrative embodiment of the present invention. The apparatus 100 alerts a telecommunications user that a party to a voice conference has returned from hold. The apparatus 100 includes a detection device 110, an alarm 120, and a sound generator 130, a processor 140, and a communications interface 150, all interconnected by bus 101. The detection device 110 detects when the telecommunications device has been placed in a hold mode and when the telecommunications device has been removed from the hold mode. The detection performed by detection device 110 may be based on sound. The sound may comprise one or more tones or any other sound(s). For example, the detection device 110 may detect when the telecommunications device has been removed from hold by the receipt of one or more Dual-Tone Multi Frequency (DTMF) tones. As another example, the detection device 110 may detect when the telecommunications device has been removed from hold by detecting a change from silence to any sound, particularly sound corresponding to human speech. Moreover, as an example of detection that does not rely upon sound, the detection device 110 may detect when the telecommunications device has been removed from hold by the receipt of a hold termination packet in, e.g., a Voice over Internet Protocol (VoIP) voice conference. The hold termination packet may be transmitted through the same data line that is used for voice data, or through an additional data line. The alarm 120 generates an audible and/or visual alarm upon detecting that the user has been removed from the hold mode. The sound generator 130 generates one or more sounds (e.g., DTMF tones or any other sounds) to indicate that the user of the telecommunications device is placing another party to a voice conference in hold mode and/or removing the other party from the hold mode. Processor 140 is used to control detection device 110, alarm 120, sound generator 130, and communications interface 150, both for generating and detecting control signals indicating hold related modes (e.g., being paced on hold, termination of a hold sequence, and the like). Communications interface 150 enables communications between apparatus 100 and telecommunications devices operable on a communications network (e.g., Internet, PSTN, cellular network, and the like).

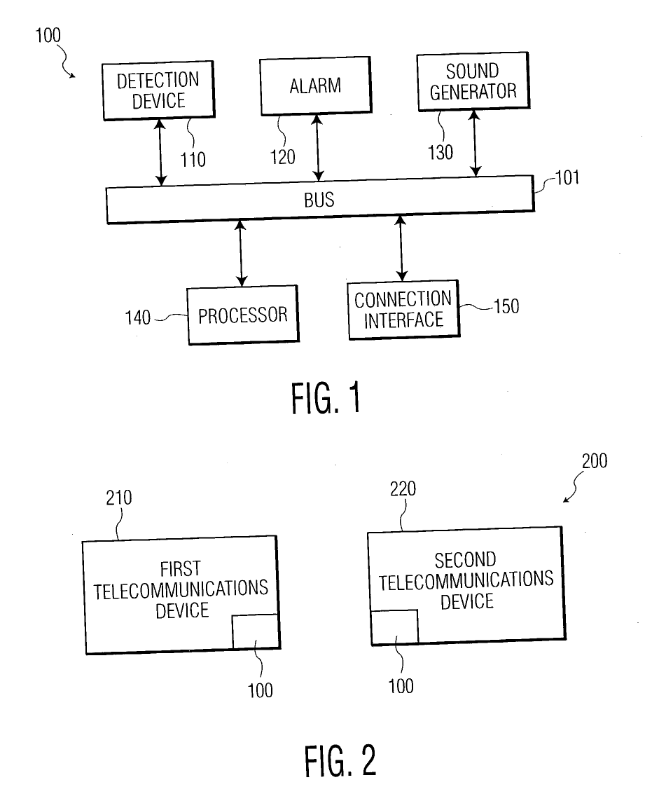

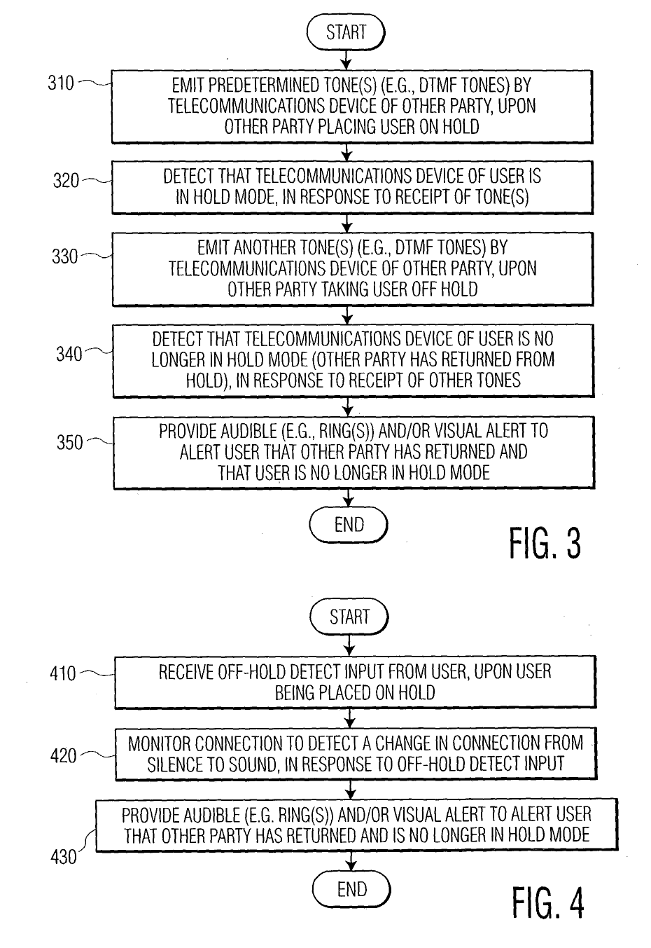

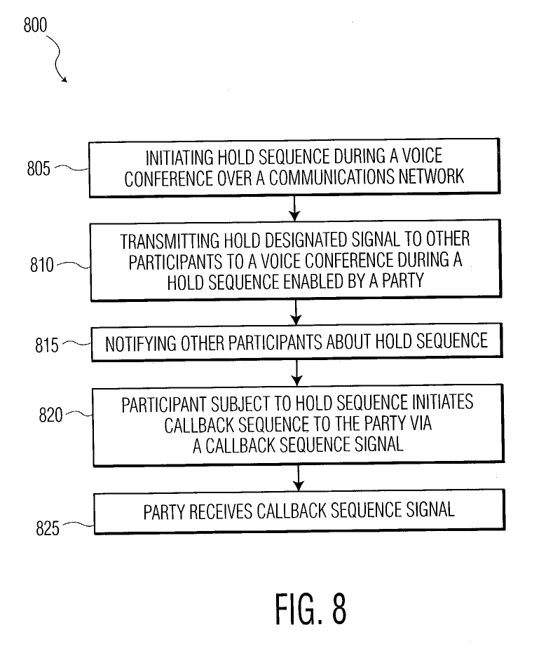

Two or more telecommunications devices having a structure such as apparatus 100 may form a telecommunications system such as that described herein below with respect to FIG. 2, and that operate as described herein below with respect to FIG. 3, FIG. 4, FIG. 7, and/or FIG. 8.

FIG. 2 is a block diagram illustrating a telecommunications system 200, according to an illustrative embodiment of the present invention. The telecommunications system 200 includes at least a first telecommunications device 210 and a second telecommunications device 220. Of course, more than two telecommunications devices may be employed, (for example, a Digital Enhanced Cordless Telecommunications system using a private branch exchange or locally accessible communications network capable of operating two or more connections to a voice conference) while maintaining the spirit and scope of the present invention. The telecommunications devices may communicate via any means (not shown) including, but not limited to landline (e.g., Public Switched Telephone Network (PSTN)), cellular or other wireless network, Internet enabled connection, TCP/IP protocol based packet system, and any combination thereof.

In the illustrative embodiment of FIG. 2, both the first telecommunications device 210 and the second telecommunications device 220 include apparatus 100. It is to be appreciated that the inclusion of the apparatus 100 in its entirety allows both telecommunications devices 210, 220 to have the capability of detecting when the party has returned from hold. However, other variations are possible and readily contemplated by one of ordinary skill in the art. For example, it may be desirable that only one telecommunications device in a system has the capability of detecting when a user of another telecommunications device(s) in the system has returned from hold. In such a case, the other telecommunications device(s) does not require the detection device 110 or the alarm 120.

FIG. 3 is a block diagram illustrating a method for alerting a telecommunications user that the other party to a voice conference has returned from hold, according to an illustrative embodiment of the present invention. While the method of FIG. 3 is described with respect to two telecommunications devices and to a voice conference having two parties, the present invention is equally applicable to more than two telecommunications devices and to a voice conference having more than two parties.

Upon the other party placing the telecommunications user on hold during a call, the telecommunications device of the other party emits a predetermined tone or sequence of tones (hereinafter “tones”) (step 310). These tones can be taken from the standard Dual-Tone Multi Frequency (DTMF) tones, or other tones may be used.

In response to receiving the tones, the telecommunications device of the telecommunications user detects that it is in hold mode (step 320). The telecommunications user can then walk away from the telecommunications device, if the telecommunications user so desires.

Upon the other party taking the telecommunications user off of the hold mode, the telecommunications device of the other party emits another tone or sequence of tones (hereinafter “other tones”) (step 330). In response to receiving the other tones, the telecommunications device of the telecommunications user detects that it is no longer in hold mode (i.e., the other party has returned and has taken the telecommunications user off of the hold mode) (step 340). The telecommunications device of the telecommunications user then provides an audible and/or visual alert (e.g., ring or any other sound or indicator) to alert the telecommunications user that the other party has returned and that the telecommunications user is no longer in hold mode (step 350).

The illustrative embodiment of FIG. 3 may be employed even if music or other announcements are played during the hold period (e.g., many companies play music when their callers are on hold). Moreover, while the method of FIG. 3 makes reference to tones, any other sound(s) may also be employed in accordance with the present invention.

An embodiment of the present invention may also be implemented using the method of FIG. 3, specifically by using data packets to notify a telecommunications device that a user has either been placed in or out of a hold mode. For example, a data packet utilizes a data field for storing an operational code, e.g., a user definable or network definable data field. The data field has a four digit operational code (e.g., 0000) to represent that a user has been placed on hold, and another operation code (e.g., 1111) to represent that the user has been placed out of a hold state. The length and coding of an operational code, as well as its location in a data packet or signal, are variable depending on the needs of a system.

FIG. 4 is a block diagram illustrating a method for alerting a telecommunications user that the other party to the voice conference has returned from hold, according to another illustrative embodiment of the present invention.

When one party puts another party on hold, there will often be silence. Thus, upon the telecommunications user being placed on hold, an OFF-HOLD DETECT input may be received from the telecommunications user (step 410). For example, the telecommunications user may depress a button labeled OFF-HOLD DETECT to enable this feature, and so forth. Upon the telecommunications user providing the OFF-HOLD DETECT input, the telecommunications user may walk away from the telecommunications device.

In response to the OFF-HOLD DETECT input, the telecommunications device of the telecommunications user monitors the connection between the telecommunications user and the other party to detect a change in the connection from silence (on-hold) to sound (off-hold, other party has returned) (step 420). Upon detecting the change in the connection, the telecommunications device of the telecommunications user provides an audible and/or visual alert (e.g., ring or any other sound or indicator) to alert the telecommunications user that the other party has returned and that the telecommunications user is no longer on hold (step 430).

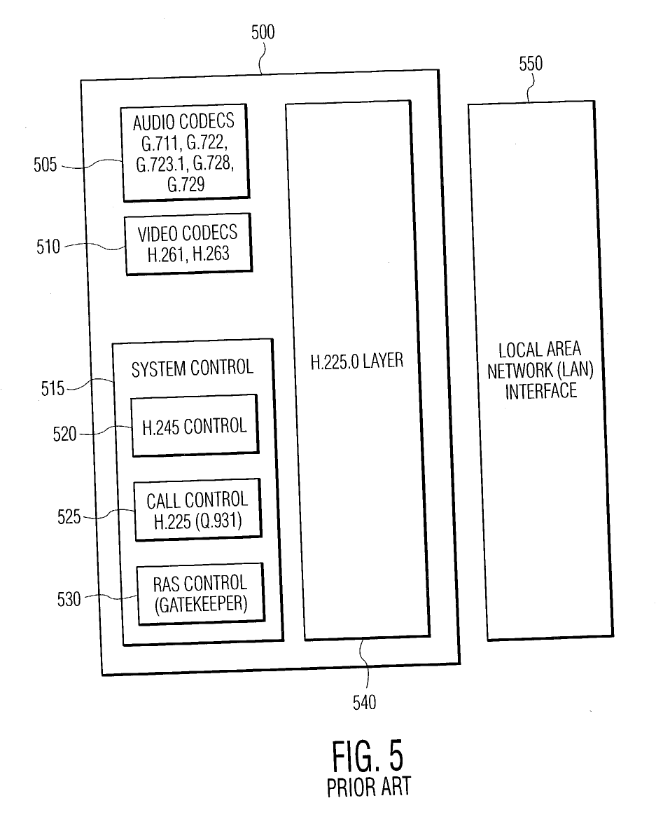

FIG. 5 is a system diagram illustrating a H.323 terminal 500 and a Local Area Network (LAN) interface 550 for enabling a Voice over Internet Protocol (VoIP)/Video Conferencing System utilizing the H.323 standard, according to the prior art. The H.323 terminal 500 includes a microphone/speaker module 505, a camera/display module 510, a system control module 515, and an H.225.0 layer 540. The system control module 515 includes an H.245 control module 520, a call control H.225 (Q.931) module 525, and a Registration, Admission, and Status (RAS) control (gatekeeper) module 530. This system diagram provides an example of architecture for enabling the present invention.

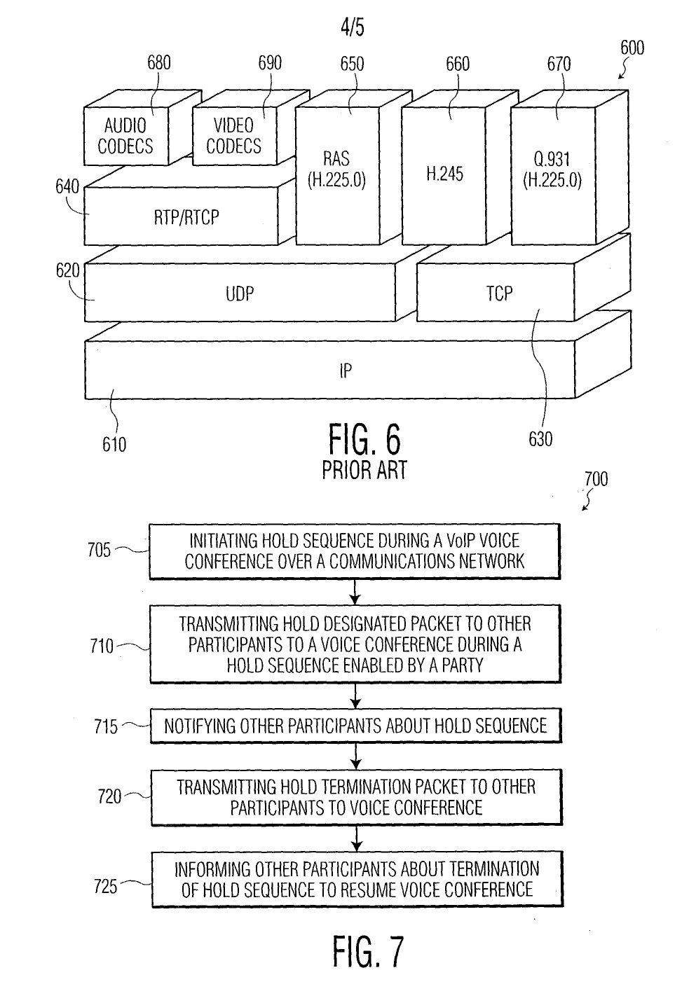

FIG. 6 is a diagram illustrating a H.323 protocol stack 600, according to the prior art. The protocol stack 600 includes an IP layer 610, a User Datagram Protocol (UDP) layer 620, a Transmission Control Protocol (TCP) layer 630, a Real Time Protocol (RTP)/Real Time Control Protocol (RTCP) layer 640, a RAS (H.225.0) layer 650, an H.245 layer 660, a Q.931 (H.225.0) layer 670, an audio codecs layer 680, and a video codecs layer 690.

FIG. 7 is a flow diagram illustrating a method 700 for a Voice over Internet Protocol (VoIP) based conference system, according to an illustrative embodiment of the present invention. A party (other party, as referred to above) initiates a hold sequence during a VoIP voice conference over a communications network (step 705). A hold-designated packet is transmitted to other telecommunication users (hereby known as “participant(s)”) of the voice conference during the hold sequence (step 710). Such a hold packet may utilize fields in the protocol stack that are customizable either based on the needs of a participants or the communications architecture. For example, a code notifying a participant about a hold mode may be placed in the RAS, and/or in other places. The other participants are notified of the hold sequence (step 715) by receiving the hold packet.

A hold termination packet is transmitted to the other participants (step 720). The party initiates the transmission of the hold termination packet by terminating the hold sequence, which in turn generates the hold termination packet. The other participants are informed of the termination of the hold sequence so that the VoIP voice conference can be resumed (step 725).

FIG. 8 is a flow diagram illustrating a method for a participant subject to a hold sequence to enable a callback sequence to a party placing the participant on hold. Callback sequences enable a participant subject to a hold sequence to leave feedback to a party placing the participant on hold, such feedback includes a voice mail message, a pager number, an e-mail message, and the like. For example, the participant leaves a message on a SMS compatible system for the party to contact the participant.

A party initiates a hold sequence during a voice conference over a communications network (step 805). A hold-designated signal (such as a DTMF tone, packetized data signal, and the like) is transmitted to other participants of the voice conference during the hold sequence, which has been enabled by the party (step 810). Other participants to the voice conference are notified about the hold sequence through audible and/or visual means (step 815).

A participant that is subject to the hold sequence initiates a callback sequence to the party via a callback sequence signal generated in response to an action by the participant (step 820). Options to generate a callback sequence comprise as the participant entering a DTMF tone code sequence on their phone keypad, use of a DTMF controlled options menu, a voice activated option via voice recognition software, a feature button located on a telecommunications device operated by the participant, and the like. Optionally, the participant leaves a callback number for the party to reach the participant at after the hold sequence is terminated.

The party receives the callback sequence signal via a telecommunications device operated by the party, a pager, a wireless messaging device, and/or other notification device (step 825). The callback sequence information being processed by the telecommunications device or architecture to supply the party with status information related to the participant placed on hold (e.g., a phone number, a voice and/or text message explaining why the participant had to terminate the conversation, and the like).

Although the illustrative embodiments have been described herein with reference to the accompanying drawings, it is to be understood that the present invention is not limited to those precise embodiments, and that various other changes and modifications may be affected therein by one skilled in the art without departing from the scope or spirit of the invention. All such changes and modifications are intended to be included within the scope of the invention as defined by the appended claims.

What is claimed is:

1. A method for facilitating the use of a telecommunications device by a party to a voice conference comprising the steps of:
detecting when a party to the voice conference has returned from a hold mode that has disengaged the voice conference; and
alerting a telecommunications user, in response to a result of said detecting step, informing the telecommunications user about the re-engagement of the voice conference.

2. The method of claim 1, wherein said detecting step comprises the step of receiving a hold termination signal indicating that the party to the voice conference has returned from hold.

3. The method of claim 2, further comprising the step of receiving a hold signal indicating that the party has placed the telecommunications user on hold.

4. The method of claim 2, wherein said hold termination signal comprises at least one of: one or multiple sounds; a data packet, one or more Dual-Tone Multi Frequency (DTMF) tones.

5. The method of claim 1, wherein said detecting step comprises the step of detecting a change in a connection between the telecommunications user and the party by detecting a threshold level of sound, wherein said threshold level of sound is detected while the telecommunications user is on hold.

6. The method of claim 1, wherein said providing step comprises the step of providing at least one of an audible alert and a visual alert.

7. The method of claim 1, wherein the audible alert comprises one or more rings.

8. The method of claim 1, wherein the voice conference is a Voice over Internet Protocol (VoIP) voice conference.

9. In combination with a telecommunications device, an apparatus comprising:
a detecting device for detecting when a party to a voice conference has returned from a hold mode that has disengaged a voice conference; and
an alerting device providing an alert to a telecommunications user, in response to a result of said detecting step, informing the telecommunications user about the re-engagement of the voice conference.

10. The apparatus of claim 9, wherein said detection device comprises the step of receiving a hold termination signal indicating that the party to the voice conference has returned from hold.

11. The apparatus of claim 10 wherein said detection device detects a hold signal indicating that the party has placed the telecommunications user on hold.

12. The apparatus of claim 9, wherein said hold termination signal comprises at least one of: one or multiple sounds; a data packet, one or more Dual-Tone Multi Frequency (DTMF) tones.

13. The apparatus of claim 9, wherein said detection device comprises detecting a change in a connection between the telecommunications user and the party by detecting a threshold level of sound, wherein said threshold level of sound is detected while the telecommunications user is on hold.

14. The apparatus of claim 9, wherein said providing step comprises the step of providing at least one of an audible alert and a visual alert.

15. The method of claim 9, wherein the audible alert comprises one or more rings.

16. The method of claim 9, wherein the voice conference is a Voice over Internet Protocol (VoIP) voice conference.

17. In combination with a telecommunications device, an apparatus comprising:
means for detecting when a party to a voice conference has returned from a hold mode that has disengaged a voice conference; and
means for alerting to alert a telecommunications user, in response to a result of said detecting step, informing the telecommunications user about the re-engagement of the voice conference.

18. The apparatus of claim 17, wherein said means for detecting comprises receiving a hold termination signal indicating that the party to the voice conference has returned from hold.

19. The apparatus of claim 18 wherein said means for detecting detects a hold signal indicating that the party has placed the telecommunications user on hold.

20. An apparatus for notifying a party with a callback sequence controlled by a participant to a voice conference, wherein said hold sequence, initiated by the party, occurs during said voice conference, comprising:
a processor for initiating the callback sequence and generating feedback comprising said callback sequence, wherein said initiation will terminate said hold sequence; and
a communications interface for transmitting said hold sequence.

21. The apparatus of claim 20, wherein said processor for initiating the callback sequence is enabled by at least one of: entering a DTMF tone code sequence on using a DTMF controlled options menu, speaking to control a voice activated option, and enabling a feature button.

22. An apparatus for notifying a party with a callback sequence controlled by a participant to a voice conference, wherein said hold sequence, initiated by the party, occurs during said voice conference, comprising:
a communications interface that receives information related to said callback sequence; and
an alert device for providing an alert to the party, when responding to feedback information of said callback sequence.

23. The apparatus of claim 22, wherein said feedback is at least one of: a voice mail message, a pager number, and a text message.
